(19) United States
(12) Patent Application Publication
(10) Pub. No.: US 2014/0118898 A1
(43) Pub. Date: May 1, 2014

(54) ELECTRONIC DEVICE

(71) Applicants: Inventec (Pudong) Technology Corporation, (US); INVENTEC CORPORATION, Taipei (TW)

(72) Inventor: Fan-Jung Tseng, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/777,758

(22) Filed: Feb. 26, 2013

(30) Foreign Application Priority Data
Oct. 26, 2012 (CN) 201210418465.X

(51) Int. Cl. H01R 24/76

(52) U.S. Cl. CPC H01R 24/76
USPC 361/679.01

(57) ABSTRACT

An electronic device includes a case, a cover and a connection port. The case has an opening and at least one rail. The opening is disposed on a side of the case. The cover, disposed at the opening, has a first end and a second end. The first end is pivotally disposed in the rail and adapted to move between a first position and a second position along the rail. The connection port is disposed inside the case. When the cover is at the first position, the cover covers at least one part of the opening. When the cover is at the second position, the second end of the cover is adapted to rotate toward a direction further away from the case to expose the connection port.

### CROSS-REFERENCE TO RELATED APPLICATIONS

This non-provisional application claims priority under 35 U.S.C. §119(a) on Patent Application No(s). 201210418465.X filed in, R.O.C. on Oct. 26, 2012, the entire contents of which are hereby incorporated by reference.

### BACKGROUND

1. Technical Field

The disclosure relates to an electronic device, and more particularly to an electronic device having a connection port.

2. Related Art

In recent years, portable electronic devices are becoming more and more popular. For the comfort and convenience of viewing, the length and width of a display of the electronic devices can not be too small. Otherwise, it will be uncomfortable and inconvenient for users to view the display. However, the size and weight of electronic devices can not be too large or heavy in order to benefit portability. Therefore, the development trend for electronic devices is the slim design which is always being emphasized in introducing products. Furthermore, many electronic devices are artistically designed with the outer edge thickness thinner than the rest of the main body.

However, it is difficult to change the dimension and specification of connection ports in order that the connection ports still needs to fit various kinds of the electronic devices. The thickness of an RJ45 connection port and that of a USB type-A connector are usually greater than those of other connection ports with different specifications, and connection ports are usually disposed on the outer edge of electronic devices. Consequently, it becomes an obstacle to the slim design of the electronic device.

Therefore, it is highly demanded for designing slim electronic devices equipped with connection ports.

### SUMMARY

This disclosure provides an electronic device comprising a case, a cover and a connection port. The case has an opening and at least one rail. The opening is disposed on a side. The cover, disposed at the opening, has a first end and a second end. The first end is pivotally disposed in the rail and adapted to move between a first position and a second position along the rail. The connection port is disposed inside the case. When the cover is at the first position, the cover covers at least one part of the opening. When the cover is at the second position, the second end of the cover is adapted to rotate toward a direction away from the case to expose the connection port.

### BRIEF DESCRIPTION OF THE DRAWINGS

The disclosure will become more fully understood from the detailed description given herein below and the accompanying drawings which are given by way of illustration only, and thus are not limitative of the disclosure and wherein:

FIG. 1 is a perspective view of an electronic device according to an embodiment of the disclosure;

FIG. 2A is an exploded perspective view of the electronic device of FIG. 1;

FIG. 2B is an exploded perspective view of a part of the electronic device of FIG. 1;

FIG. 3A is a sectional side view of a cover of the electronic device of FIG. 1 at a first position;

FIG. 3B is a sectional side view of the cover of the electronic device of FIG. 1 at a second position; and

FIG. 3C is a sectional side view of a fully uncovered connection port and the cover of the electronic device of FIG. 1.

### DETAILED DESCRIPTION

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

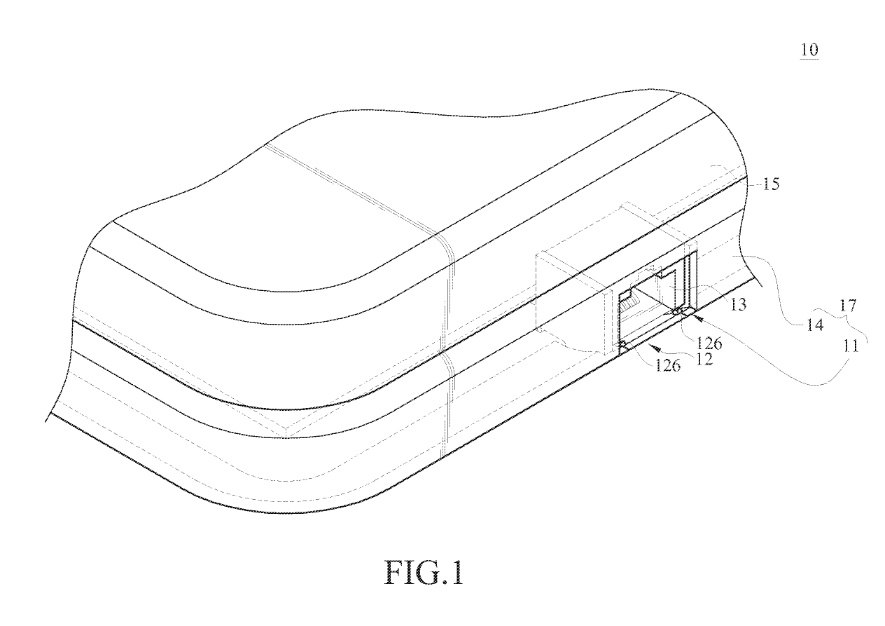

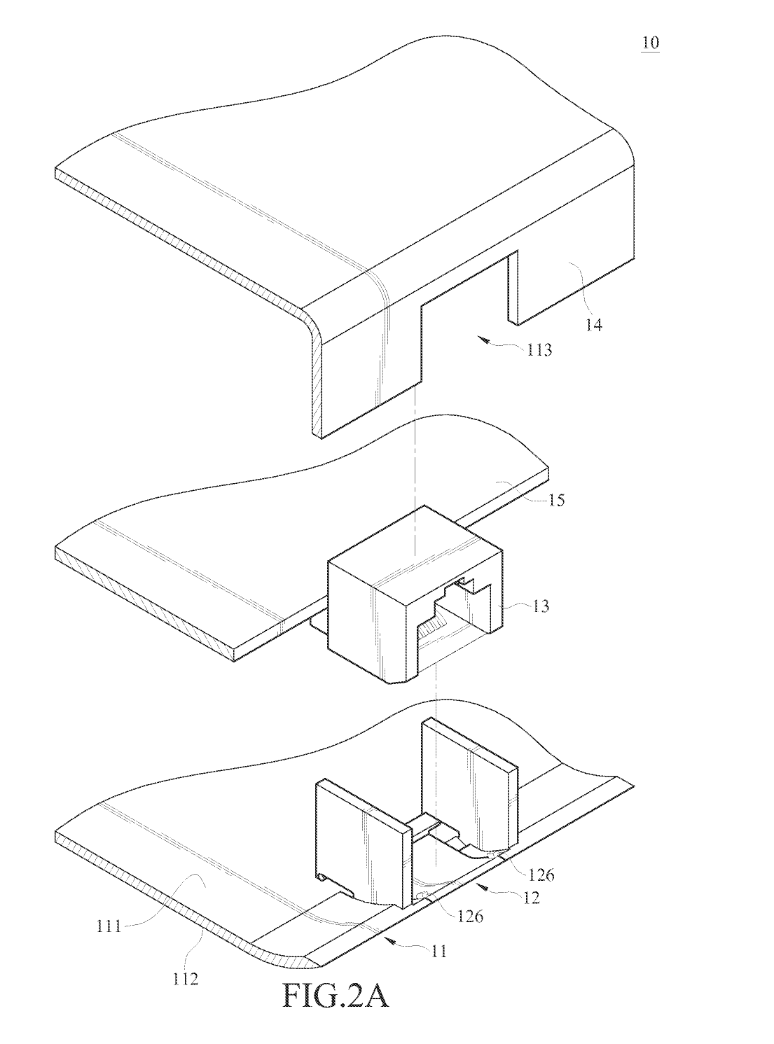

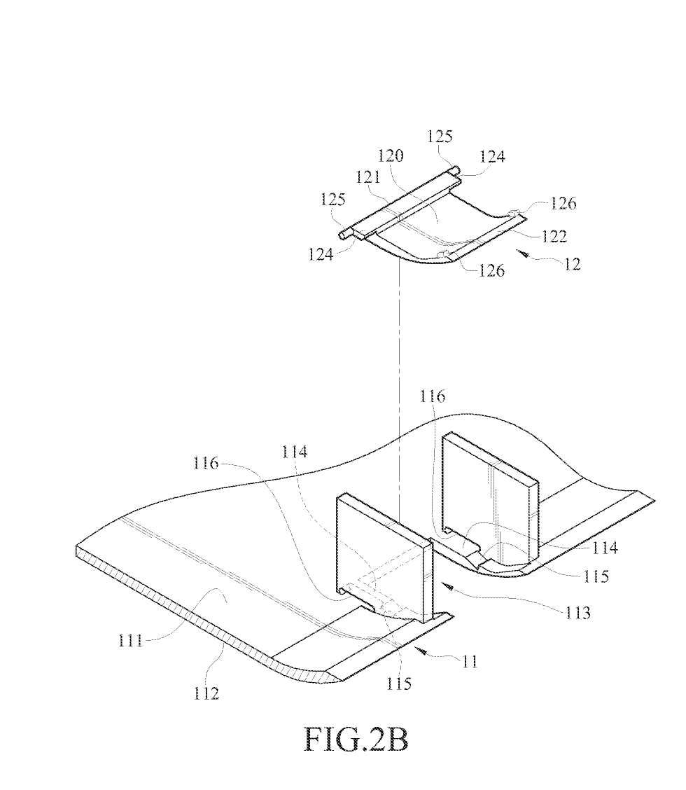

Please refer to FIGS. 1, 2A and 2B. FIG. 1 is a perspective view of an electronic device 10 according to an embodiment of the disclosure. FIG. 2A is an exploded perspective view of the electronic device 10 of FIG. 1. FIG. 2B is an exploded perspective view of a part of the electronic device 10 of FIG. 1. The electronic device 10 of the disclosure comprises a bottom case 11, a cover 12, a connection port 13, a top case 14 and a motherboard 15.

The bottom case 11 and the top case 14 together form a case 17. The top case 14 covers the bottom case 11. The bottom case 11 has a bottom case inner surface 111 and a bottom case outer surface 112. The case 17 has an opening 113 formed between the bottom case 11 and the top case 14. In other embodiments, the opening 113 may be disposed on the top case 14 alone or disposed on the bottom case 11 alone. In this embodiment, a part of the opening 113 is disposed on an outer edge of the bottom case 11, and another part of the opening 113 is disposed on an outer edge of the top case 14. The case 17 has a pair of rails 116 disposed therein.

The cover 12 is disposed at the opening 113. The cover 12 has a first end 121 and a second end 122. The first end 121 is pivotally disposed in the rails 116 and is adapted to move between a first position and a second position along the rails 116. The connection port 13 is disposed between the bottom case 11 and the top case 14. When the cover 12 is at the first position, the cover 12 covers at least one part of the opening 113. When the cover 12 is at the second position, the second end 122 of the cover 12 is adapted to rotate toward a direction away from the bottom case 11 to expose the connection port 13. The motherboard 15 is electrically connected to the connection port 13. For example, the connection port 13 may be an RJ45 connection port or a USB connection port, but not limited to the disclosure. Moreover, an area covered by the cover 12 is smaller than the opening 113.

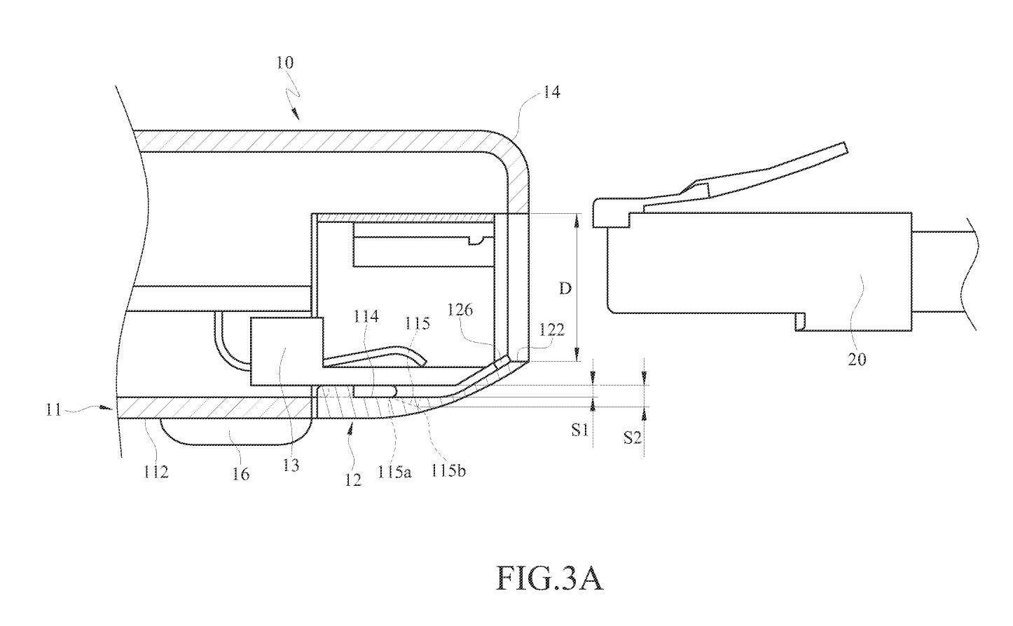

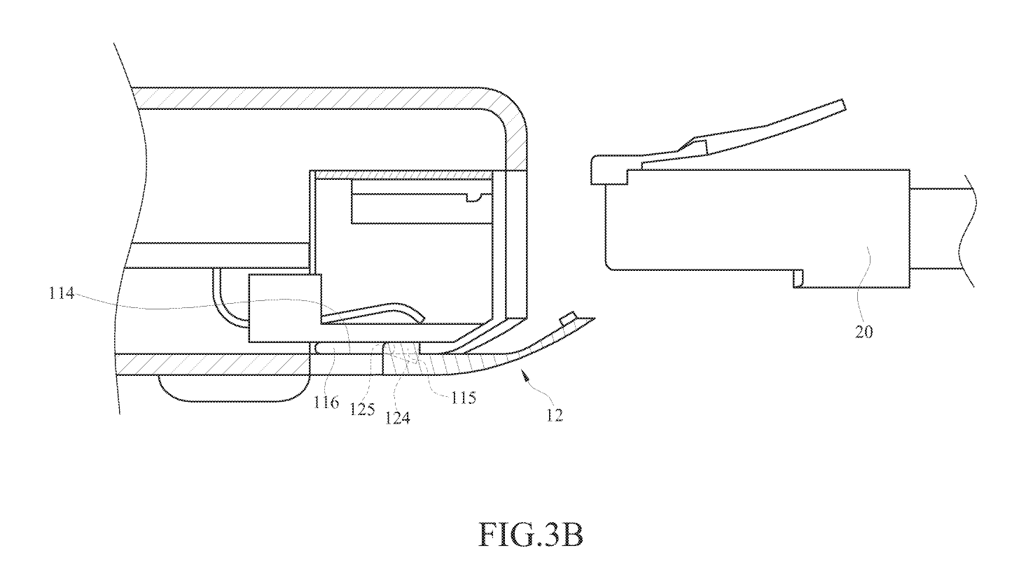

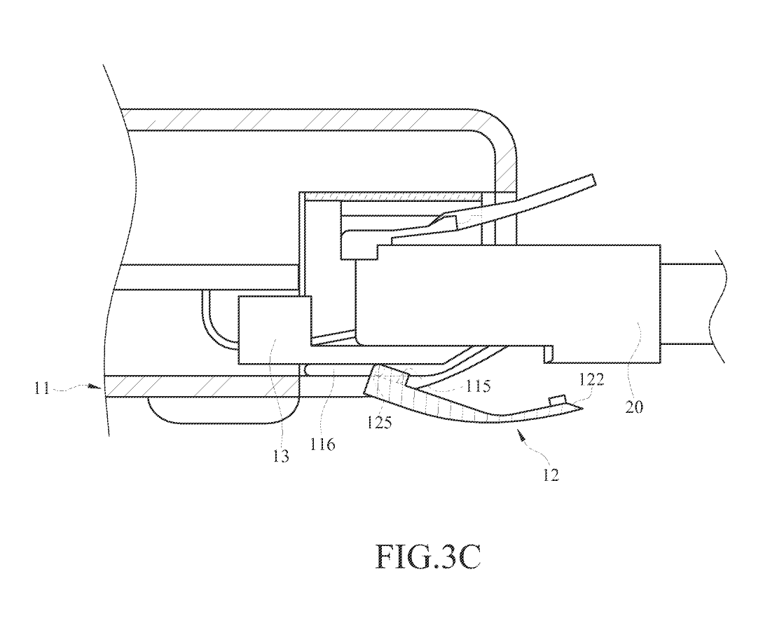

Please refer to FIG. 3A together. FIG. 3A is a sectional side view of the cover 12 of the electronic device 10 of FIG. 1. In FIG. 3A, the cover 12 is disposed at the first position. In this embodiment, the rails 116 are disposed between the bottom case outer surface 112 and the connection port 13. The bottom case 11 includes a pair of supporting platforms 114 and a pair of supporting beveled surfaces 115. The supporting platforms 114 and the supporting beveled surfaces 115 are all disposed on the bottom case inner surface 111.

Furthermore, the pair of supporting platforms 114 is disposed adjacent to the rails 116. Each of the supporting beveled surfaces 115 has a first edge 115a and a second edge 115b which are opposite to each other. Each of the first edges 115a is connected to the corresponding supporting platforms 114. A first distance Si between each of the first edges 115a and the connection port 13 is smaller than a second distance S2 between each of the second edges 115b and the connection port 13.

As shown in FIG. 2B, the cover 12 includes a pair of supporting plates 124 and a pair of shafts 125. The supporting plates 124 are disposed between the first end 121 and the second end 122. The pair of shafts 125 is disposed on outer edges of the supporting plates 124. Furthermore, the pair of supporting plates 124 and the pair of shafts 125 are disposed at the first end 121. The shafts 125 are disposed in the rails 116 inside the bottom case 11. When the cover 12 is at the first position, the supporting plates 124 are adapted to move along the supporting platforms 114. When the cover 12 is at the second position, the shafts 125 are adjacent to the supporting beveled surfaces 115, and the supporting plates 124 are adapted to rotate to the supporting beveled surfaces 115 using the shafts 125 as the axis. The cover 12 has a cover inner surface 120. The cover 12 includes a pair of fastening elements 126 disposed on the cover inner surface 120. As shown in FIG. 2A, when the cover 12 is at the first position, the fastening elements 126 are interfered with the bottom case 11 and thus fastened with the bottom case 11. Each of the fastening elements 126 may have a protruding piece. When the cover 12 is at the first position, the protruding pieces are interfered with the bottom case 11 and thus fastened with the bottom case 11. In this embodiment, the number of the fastening elements 126 is two, but not limited to the disclosure. In other embodiments, the number of the fastening elements 126 may be one or more than two. Moreover, in this embodiment, an area covered by the cover 12 is smaller than the area covered by the opening 113.

Please refer to FIGS. 3A, 3B and 3C. FIG. 3B is a sectional side view of the cover 12 of the electronic device 10 of FIG. 1. In FIG. 3B, the cover 12 is disposed at the second position. FIG. 3C is a sectional side view of the cover 12 of the electronic device 10 of FIG. 1. In FIG. 3C, the connection port 13 is exposed. In this embodiment, the connection port 13 is regarded as an RJ45 connection port as an example. FIGS. 3A, 3B and 3C show how an RJ45 cable connector 20 is connected to the electronic device 10. The electronic device 10 further comprises a rubber pad 16 disposed on the bottom case outer surface 112 of the bottom case 11. As shown in FIG. 3A, when the cover 12 is at the first position, the cover 12 covers the connection port 13, and the fastening elements 126 are fastened with the bottom case 11. The second end 122 of the cover 12 and the top case 14 are separated by a distance D, and therefore a part of the connection port 13 is exposed between the second end 122 of the cover 12 and the top case 14 such that the cover 12 covers a part of the connection port 13.

As shown in FIG. 3B, the shafts 125 are moved to the right along the rails 116. Along with the shafts 125, the supporting plates 124 may also be moved to the right along the supporting platforms 114. Thereby, the cover 12 is moved to the second position. At this moment, the shafts 125 of the cover 12 are disposed adjacent to the supporting beveled surfaces 115.

As shown in FIG. 3C, when the shafts 125 of the case 12 are disposed adjacent to the supporting beveled surfaces 115, the cover 12 may be rotated around the shafts 125 as the axis. Therefore, the second end 122 of the cover 12 may be rotated toward a direction further away from the bottom case 11. At this moment, the connection port 13 is exposed and the cable connector 20 may be inserted into the connection port 13 to be electrically connected with the connection port 13.

As shown in FIG. 3B, when the cable connector 20 is electrically disconnected from the connection port 13, the cover 12 may be rotated around the shafts 125 as the axis and causes the supporting plates 124 to turn away from the supporting beveled surfaces 115 by using the shafts 125 as the axis. At this moment, the cover 12 may be rotated to the second position. Then, the cover 12 is pushed toward the left. The shafts 125 may be moved to the left along the rails 116 and the supporting plates 124 may be moved to the left along the supporting platforms 114 to cause the cover 12 to move to the first position. As shown in FIG. 3A, the fastening elements 126 are fastened with the bottom case 11 again, and the case 12 covers a part of the connection port 13. Since the cover 12 is pulled to the right first before turned clockwise, a margin for rotating between the cover 12 and the bottom case 11 is not required. Thereby, the design for the combination of the cover 12 and the bottom case 11 is leveled.

According to the electronic device of the disclosure, the connection port is disposed at the opening of the bottom case, the thickness of the electronic device does not have to be made thicker in order to adapt to the thickness of the connection port. The connection port is covered by the cover and the connection port is enabled to be used after the cover is opened. The cover is moved along the rail and then be rotated so that a margin for rotating between the cover and the bottom case is not required. As a result, the exterior of the electronic device can be made flatter.

Note that the specifications relating to the above embodiments should be construed as exemplary rather than as limitative of the invention, with many variations and modifications being readily attainable by a person of average skill in the art without departing from the spirit or scope thereof as defined by the appended claims and their legal equivalents.

What is claimed is:

1. An electronic device, comprising:
a case having an opening and at least one rail, the opening disposed on a side thereon;
a cover disposed at the opening, the cover having a first end and a second end, the first end being pivotally disposed in the rail and adapted to move between a first position and a second position along the rail; and
a connection port disposed inside the case;
wherein, when the cover is at the first position, the cover covers at least one part of the opening, when the cover is at the second position, the second end of the cover is adapted to rotate toward a direction further away from the case to expose the connection port.

2. The electronic device as claimed in claim 1, wherein the connection port is an RJ45 connection port or a USB connection port.

3. The electronic device as claimed in claim 1, wherein an area covered by the cover is smaller than the opening.

4. The electronic device as claimed in claim 1, wherein the case includes at least one supporting platform and at least one supporting beveled surface, the at least one supporting platform is disposed adjacent to the rail, the at least one supporting beveled surface has a first edge and a second edge opposite to each other, the first edge is connected with the at least one supporting platform, a first distance between the first edge and the connection port is smaller than a second distance between the second edge and the connection port.

5. The electronic device as claimed in claim 4, wherein the cover comprises at least one supporting plate disposed between the first end and the second end, the at least one supporting plate includes at least one shaft disposed in the rail, when the cover is at the first position, the at least one supporting plate is adapted to move along the at least one supporting platform, when the cover is at the second position, the at least one shaft is adjacent to the at least one supporting beveled surface, and the at least one supporting plate is adapted to rotate to the at least one supporting beveled surface using the at least one shaft as the axis.

6. The electronic device as claimed in claim 5, wherein the at least one supporting plate and the at least one shaft are disposed at the first end.

7. The electronic device as claimed in claim 6, wherein the case comprises a top case and a bottom case, the top case covers the bottom case, when the cover is at the first position, the second end and the top case are separated by a gap, and a part of the connection port is exposed between the second end and the top case.

8. The electronic device as claimed in claim 1, wherein the cover comprises at least one fastening element and has a cover inner surface, the at least one fastening element is disposed on the cover inner surface, when the cover is at the first position, the fastening element is fastened with the case.

9. The electronic device as claimed in claim 8, wherein the fastening element has a protruding piece, when the cover is at the first position, the protruding piece is interfered with the case and therefore fastened with the case.

10. The electronic device as claimed in claim 1, further comprising a motherboard electrically connected with the connection port.
